(19) United States
(12) Patent Application Publication
(10) Pub. No.: US 2026/0029275 A1
(43) Pub. Date: Jan. 29, 2026

(54) SYSTEM AND METHOD FOR WIRED/WIRELESS, ONLINE/OFFLINE COMMUNICATION-BASED CONTINUOUS, REAL-TIME PROPORTIONAL AND RADIOMETRIC MEASUREMENT - PROCESSING - MONITORING OF THE OUTPUT OF UV SOURCES

(71) Applicant: RND ARASTIRMA GELISTIRME TASARIM MAKINE SANAYI VE TICARET LIMITED SIRKETI, ÇIGLI (TR)

(72) Inventor: Neil Avner ÇIKUREL, ÇIGLI (TR)

(21) Appl. No.: 18/785,359

(22) Filed: Jul. 26, 2024

(51) Int. Cl. G01J 1/42; G01J 1/02; H04L 67/12

(52) U.S. Cl. CPC G01J 1/429; G01J 1/0204; G01J 1/0228; G01J 1/0238; H04L 67/12

(57) ABSTRACT

Disclosed are a system and method for wired/wireless-online/offline communication-based continuous, real-time proportional and radiometric measurement, processing, and monitoring of the output of UV sources which generate UV radiation that can be used in water disinfection, surface disinfection, air, and room disinfection processes and for non-disinfection purposes. The system and method are provided to measure and monitor the UV output of the UV sources or in the environment continuously in real-time through externally placed sensors. In the system and method, data from the sensors is processed in a microprocessor-based electronic module, and the information is transmitted to an online/offline interface accessible to the end-user via wired/wireless communication.

### CROSS-REFERENCE TO RELATED APPLICATIONS

Not applicable.

### BACKGROUND OF THE INVENTION

The invention relates to a system and method for wired/wireless-online/offline communication-based continuous, real-time proportional and radiometric measurement-processing-monitoring of the output of UV sources (e.g., low-pressure UV lamps, medium-pressure UV lamps, UV LEDs, FAR UV, excimer lamps, etc.) used in devices utilizing UV technology.

Ultraviolet rays are a type of light energy from the sun. It is also called ultraviolet radiation. UV radiation stays out of the visible light spectrum. UV sources can be used in water disinfection, surface disinfection, air, room and environment disinfection processes, and for non-disinfection purposes (i.e., UV curing). Disinfection with UV sources is used as a disinfection process that inactivates microorganisms without using chemicals and heat and prevents their reproduction by disrupting their DNA and RNA structure.

Today, various methods are used to monitor UV radiation. The working principles and disadvantages of these existing methods are as follows;
1. Monitoring Window: When monitored from the monitoring window, it can only be determined whether UV sources are operating or not. Since UV is not in the visible light spectrum, only UV sources are operating or not can be observed by looking through the monitoring window. The existence of UV can only be known by measuring it.
2. Time Tracking: The UV source is replaced at the end of the usage period determined by the manufacturer. How long the UV source has been used can be measured with a timer or it can be replaced in a determined calendar period based on the manufacturer's recommendation and the determined useful life of the source, without measuring time The useful life of a UV source is influenced by various factors, including on-off cycles, operating conditions (e.g., temperature, lamp cooling, pollutant intake, lamp driver conditions). These factors can cause a decrease in the UV output of the UV sources before the manufacturer's specified lifespan or the period defined by the equipment manufacturer. Therefore, measuring the UV Source's working hours without measuring the UV throughput may lead to incorrect guidance.
3. Electrical Tracking: The activation status of the UV source can be understood by checking whether it draws current from its driver. In this measurement, it can be seen whether the current transformer and the UV source are operating. However, even if the UV source operates electrically at norm values, in case the UV source is covered with dust or different pollutants, the UV source cannot provide a sufficient dose of UV radiation to the environment. Therefore, the information obtained electrically that the UV source is operating may lead to incorrect guidance.
4. Optical Tracking: It is tried to measure/monitor UV output by using sensors that detect/measure wavelengths outside the UV spectrum. However, since such sensors make assumptions about the existence of UV radiation by measuring the visible light and infrared (IR) wavelengths emitted by UV sources, they may give incorrect information based on the existence of other components emitted even when the UV source does not emit any UV radiation. Therefore, it does not serve the purpose.
5. Measurement/Tracking of UV Dose in the Environment: In the present art, the UV output in the environment is measured by positioning a single sensor into an environment that has multiple UV sources. Depending on the placement of the sensor, changes in the irradiation values of multiple UV sources (Multiple UV sources may be disabled, power values may change or sources can be covered with various pollutants.) may have too much or too little impact on the measurement.

As can be seen, in existing techniques; There are no wired/wireless-online/offline communication-based systems that measure/monitor the UV output continuously in real-time through external sensors and process the information in a microprocessor-based electronic module, transmit it as proportional and radiometric values to the interface accessible to the end user, generate warning messages depending on the quantitatives of the transmitted information, and provide outputs enabling intervention to the UV source.

In the absence of a system and method with the above-mentioned capabilities, there is a significant risk of being misled and incorrectly guided. When UV sources are used for disinfection without continuous monitoring, there may be a false assumption that the UV output is sufficient to inactivate microorganisms, when in fact, it may be inadequate. This misconception can lead to a false sense of security, only to later discover the lack of proper protection. Similarly, in non-disinfection applications where UV sources are utilized, it may be presumed that the UV output is sufficient for curing ink, but an inadequate dose can result in substantial scrap production, which is both costly and environmentally detrimental.

The invention ensures that devices utilizing UV technology maintain the necessary UV output for optimal and uninterrupted operation, thereby enabling the device to perform its function fully and flawlessly. This is achieved through continuous real-time measurement and monitoring of UV output, generating the signals to trigger appropriate alerts and interventions when UV output drops below permissible thresholds.

Moreover, the most commonly used UV sources contain mercury. Current techniques to mitigate the risk of insufficient UV dose often lead to the premature disposal of these UV sources, resulting in a significant amount of mercury-containing waste. Continuous monitoring of UV sources can prevent premature disposal, thereby reducing mercury waste and promoting sustainability.

Abstract of the application numbered TR2021/002510, which emerged as a result of technical research is that; “it consists of air purification module with UVC GI lamp, mirrored aluminum upper cover, mirrored aluminum lower body, fan—duct flange, lamp stabilizer, connector, socket, UVC GI lamp, quartz tube, outer coating, screen, power cable connection, vent, stand, dust filter and it relates to disinfecting the air passing through it and preventing the reproduction of harmful microorganisms affected by UVC light by disrupting the DNA and RNA structure”.

As can be seen, the system relates to an air purification module with UVC GI lamp and does not mention a structure that can provide a solution to the disadvantages mentioned above.

Abstract of the application numbered U.S. Pat. No. 10,960,091B2, which emerged as a result of technical research is as follows: “The invention provides a UV illumination device for sterilizing and disinfecting a desired item or area. The device is having a built-in camera and UV light source in order to disinfect and sterilize the desired item or area. The device automatically detects the human presence and acts as a normal household light and can be fit inside the conventional light bulb or tube light holder. Further, the device uses an artificial intelligence module, object detection module, machine learning module, localization module, and a plurality of sensors to easily detect the application area and act according to parameters of a particular item. Furthermore, the device can be manually controlled by using a remote device which is having a display where the user can select, identify, prioritize the items and can adjust the time and intensity of the light projection based upon his/her own intellect.”

As can be seen, the invention relates to a system and method for disinfection using ultraviolet radiation and does not mention an embodiment that can provide a solution to the above-mentioned disadvantages.

As a result, there is a need for development in the relevant technical field due to the negativities described above and the inadequacy of existing solutions on the subject.

### SUMMARY OF THE INVENTION

The invention aims to introduce a structure with different technical features that bring a new perspective to this field, unlike the structures used in the present art.

The main purpose of the invention is to measure and monitor the UV output of the UV sources or in the environment continuously in real-time through externally placed sensors and process it in a microprocessor-based electronic module, transmitting the information to an online/offline interface accessible to the end-user via wired/wireless communication. Thus, continuously measuring and monitoring the current operational status and efficiency of UV sources.

A purpose of the invention is to determine and monitor whether the UV source is operating and to measure the output continuously. Based on this measurement and processed information, the system can alert the end user or automatically adjust the UV source driver (if driver permits) or other peripherical elements (i.e., dampers, fan speed, etc.) according to pre-set settings and algorithm running in the electronic module or through intervention by an authorized user, thereby decreasing or increasing the output.

Another purpose of the invention is to accurately measure continuously the output of UV sources, which is directly related to the temperature conditions of the environment in which they operate, and their operating time. The system can either perform an automatic calibration by taking the current measured value as the highest reference value or a manual calibration by allowing an authorized user to assign the current measured value as the highest reference value. The system allows the measured value to be assigned as the highest reference value (one hundred percent) as well as the ability to assign it to any desired ratio (seventy percent, fifty percent, etc.).

Another purpose of the invention is to receive and process information from external sensors (i.e., temperature, relative humidity, pressure, air velocity, air quality, etc.) that can be integrated into the system. It is to create an algorithm that evaluates the relationship between processed information and UV output.

Another purpose of the invention is to use the results of the algorithm's outputs to inform the authorized users via the interface about the duration and output values required to improve the air quality or to inactivate pathogens and/or to control all other external elements (i.e., fans, dampers, etc.) that affect indoor air quality.

Another purpose of the invention is to display the measured UV output value as a percentage (proportional to the initial/calibrated measurement) to the end user. In the system, which is subject of the invention, the sensor can be operated as a radiometer. In this case, the results can be shared accordingly as absolute UV irradiance values. In addition, the results of measurements made with different sensors (i.e., temperature, relative humidity, pressure, air velocity, air quality, etc.,) are evaluated within the specifically created algorithm to display the UV dose value and time required to achieve disinfection of specified pathogens. The system, which allows the use of different sensors together, enables environmental conditions to be evaluated integrally and necessary warnings and interventions to be made. Examples of sensors that can be used: Carbon dioxide sensor, ethylene sensor, sensors that measure indoor air quality, particulate matter sensors, etc.

Another purpose of the invention is to assign automatically an address to the UV Sources that are monitored by the microprocessor-based electronic module and to automatically assign the master/slave modules and transmit the information received from a multi-module structure to the user interface as one single module.

In order to achieve the objectives described above, the invention is a system for wired/wireless-online/offline communication-based continuous real-time proportional and radiometric measurement, processing, and monitoring of the output of UV sources (10) which generates UV radiation that can be used in water disinfection, surface disinfection, air and room disinfection processes and for non-disinfection purposes, characterized by comprising:
UV sensor/s (20) which is positioned where the UV source/s (10) is located and continuously measures the output of the UV source (10) and transmits the output information to an electronic module (40),
an electronic module (40) processes the data received from UV sensor/s (20),
a transmission device (41) that transmits the processed data to a cloud/server (70) or an offline medium (i.e., Building Management System-BMS),
user interface (60) displays data, time-dependent graphs of the processed signal received via electronic module (40), calibration setting, theoretical remaining life of the UV Source (10), and other information that can be requested by the user.

A preferred embodiment of the invention comprises:
a gateway (30) in which the electronic module (40) is positioned and
panel mount connector/s (35)
which connects sensor/s to the gateway (30) in order to allow connection of multiple sensors
which transmits data received from sensor/s to electronic module (40) and also provides power from the gateway (30) to said sensor/s.

A preferred embodiment of the invention comprises an AC line connection or DC source or battery, in order to provide the power requirement of the gateway (30). If an AC line connection is present, AC line connection is established through a power connection socket (34). AC is converted to DC by a Switching Mode Power Supply (SMPS) (31).

A preferred embodiment of the invention comprises a warning component (33) that generates visible and/or audible warnings in case UV output values are below the permissible set level determined in the electronic module (40). And/or when any other parameter being monitored (e.g., temperature, air velocity, relative humidity, inner air quality, etc.,) is below or above the permissible set level determined in the electronic module (40).

A preferred embodiment of the invention comprises an adjustment component (32) which performs:
selecting the type of transmission device (41) (i.e., Bluetooth, Wi-Fi, Ethernet, GSM, etc.), and/or
selecting the mode of the transmission device (41) (i.e., set-up mode, operation mode), and/or
showing the mode of the transmission device (41) (i.e., blinking LED indicator for set-up mode, steady lit LED indicator for operation mode) visually.

A preferred embodiment of the invention comprises the transmission device (41) that can be wired or wireless (Wi-Fi, Bluetooth, GSM, Ethernet). The transmission device (41) using Wi-Fi protocols can be used as a module that can connect to a wireless internet network, or it can be used as a module that creates its wireless internet network and allows other devices to connect to it. This is done by selecting the mode of the transmission device (41).

A preferred embodiment of the invention comprises connection cable set (50) which includes the connection cable (51) and in-line cable connectors (52) that provide the electrical and data connectivity of the UV sensor/s (20), and all other sensors (if any) with the gateway (30).

In a preferred embodiment of the invention comprises said user interface (60) allows the intervention to the system based on the data provided by the embedded program running in electronic module (40) that processes the information and measurements as well as the warnings that will be transmitted to the user.

A preferred embodiment of the invention comprises at least one ambient condition measuring sensor which is positioned in devices utilizing UV technology or in the environment where the UV source is located to measure the ambient conditions (11) according to their characteristics.

In a preferred embodiment of the invention, ambient condition measuring sensor is a temperature sensor (21) measures the temperature of the environment, and/or ambient condition measuring sensor is a pressure sensor (22) measures the pressure of the environment and/or ambient condition measuring sensor is a relative humidity sensor (23) measures the relative humidity of the environment and/or ambient condition measuring sensor is an indoor air quality sensor (25) that measures the indoor air quality of the environment through sensors such as particulate matter sensors, and toxic gases sensors (carbon dioxide-ethylene).

A preferred embodiment of the invention is the user interface (60) that allows to display data, graphics, and any other requested information and provides the necessary warnings/alarms to the monitoring center or/and to the end user in the form of visual and/or audible warning on the screen/display, e-mail, SMS, etc.

A preferred embodiment of the invention the electronic module assigns the master/slave modules and transmits the information received from a multi-module structure to the user interface as one single module.

The structural and characteristic features and all the advantages of the invention will be more clearly understood by means of the figures given below and the detailed description written with references to these figures, and therefore the evaluation needs to be made by taking these figures and the detailed description into consideration.

### BRIEF DESCRIPTION OF DRAWINGS

FIG. 1 is (a general view) the Block Diagram of the system, which is the subject of the invention.

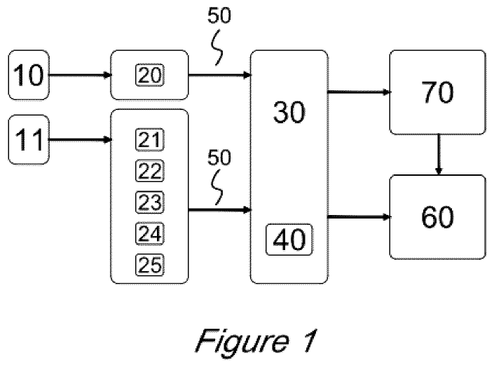

FIG. 2 is a general view of a typical setup of the system.

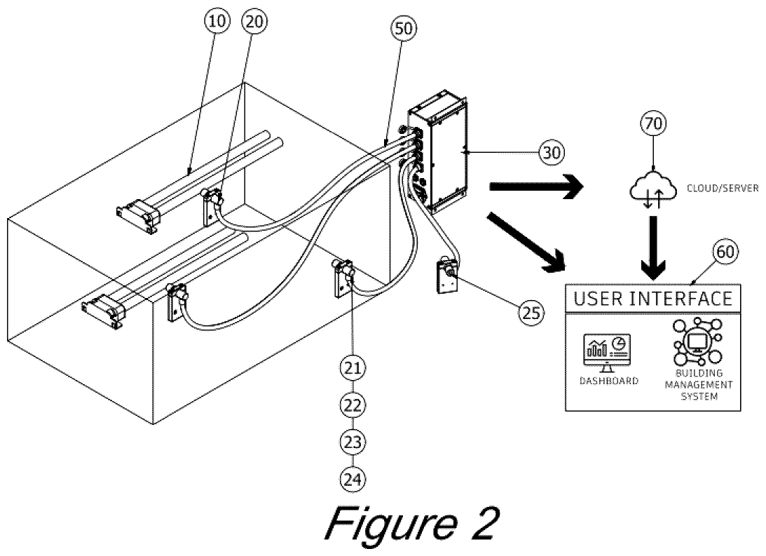

FIG. 3 shows the Gateway and Connections.

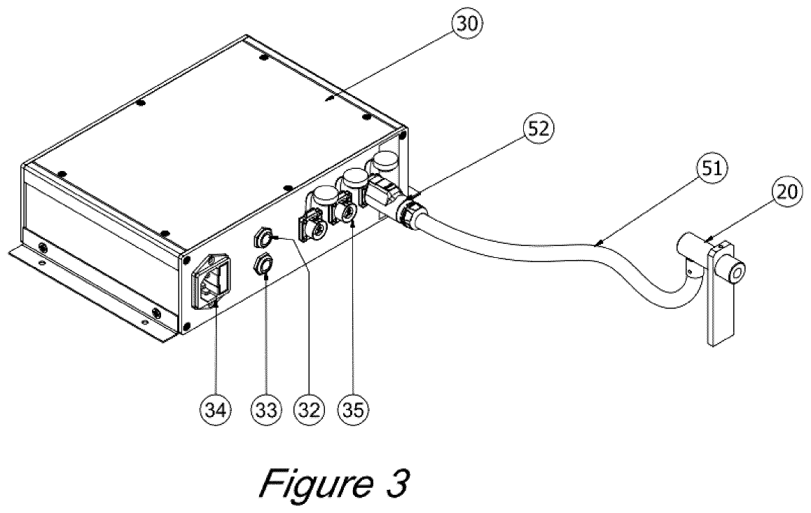

FIG. 4 shows the interior and peripherical components of the Gateway.

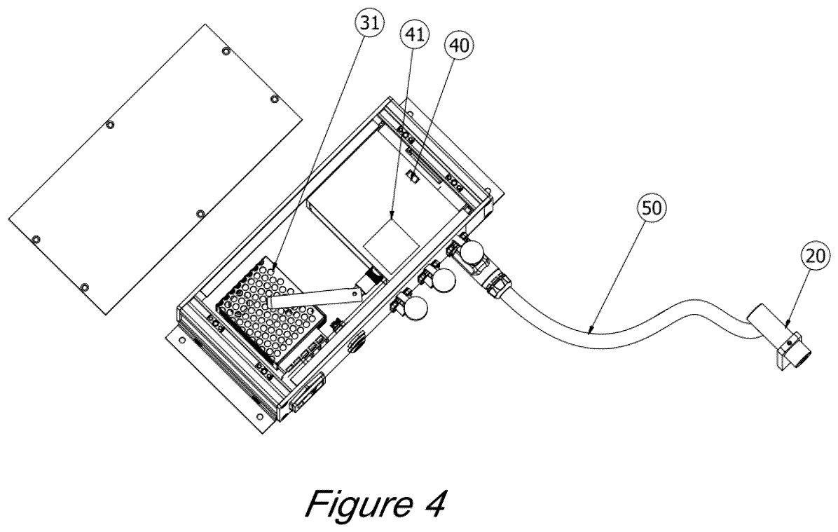

Figures do not necessarily need to be scaled, and details not necessary for understanding the present invention may be omitted. Furthermore, elements that are at least substantially identical or have at least substantially identical functions are shown with the same number.

### REFERENCE NUMBERS

10. UV source
11. Ambient condition (environment in which the UV source is located)
20. UV sensor
21. Temperature sensor
22. Pressure sensor
23. Relative humidity sensor
24. Air velocity sensor
25. Indoor air quality (IAQ) sensor
30. Gateway
31. Switching Mode Power Supply (SMPS)
32. Adjustment component
33. Warning component
34. Power connection socket
35. Panel mount connector
40. Electronic module
41. Transmission device
50. Connection cable set
51. Connection cable
52. In-line cable connector
60. User interface
70. Cloud/server

### DETAILED DESCRIPTION OF THE INVENTION

In this detailed description, preferred embodiments of the invention are described only for a better understanding of the subject and in a way that does not form any limiting effect.

The invention relates to a system and method for wired/wireless—online/offline communication-based, continuous real-time proportional and radiometric measurement-processing-monitoring of the output of UV sources used in devices utilizing UV technology

The elements and their functions used in the system, which is the subject of the invention are as follows;

The UV source (10) (e.g., low-pressure UV lamps, medium-pressure UV lamps, UV LEDs, FAR UV, excimer lamps, etc.) is the element that generates UV radiation, which can be used in water disinfection, surface disinfection, air and room disinfection processes and for non-disinfection purposes (i.e., UV curing). Besides, UV source (10) is an external element of which the throughput is measured and monitored in real-time and continuously throughout the invention.

The UV sensor (20) is positioned where the UV source (10) is located and continuously measures the output of the UV source (10). UV sensor (20) can be wired or wireless sensor or directly mounted on electronic module (40).

Ambient condition measuring sensor/s is positioned in devices utilizing UV technology or in the environment where the UV source/s is located to measure the ambient conditions (11) (i.e. temperature, relative humidity, pressure, air velocity, indoor air quality, etc.) according to their characteristics. The ambient condition measuring sensor may be the temperature sensor (21), the pressure sensor (22), the relative humidity sensor (23), the air velocity sensor (24), and the indoor air quality (IAQ) sensor (25).

The temperature sensor (21) is the sensor positioned where the UV source (10) is located and measures the temperature of the environment.

The pressure sensor (22) is the sensor positioned where the UV source (10) is located and measures the pressure of the environment.

The relative humidity sensor (23) is the sensor positioned where the UV source (10) is located and measures the relative humidity of the environment.

The air velocity sensor (24) is the sensor positioned in the environment (i.e., air handling units—AHUs, ducts) where the UV source (10) is located and measures the velocity of the air passing through the UV source/s.

The indoor air quality sensor (25) measures the indoor air quality of the environment through sensors such as particulate matter sensors, and toxic gas sensors (i.e., carbon dioxide-ethylene, etc.).

Not limited by above-mentioned sensors, multiple and different types of sensors can be connected to the system. Said sensors could be utilized to measure/monitor the parameters affecting the UV output of the UV sources and/or to measure/monitor the efficacy achieved through the use of UV technology in the environment.

UV sensor/s (20) and/or ambient condition measuring sensor/s (if any) are connected to the gateway by connection cable set (50) or wirelessly.

Connection Cable Set (50) comprising the Connection cable (51) and In-line cable connectors (52) are in a structure that will not be affected by UV radiation and external influences and provide the electrical and data connection of the UV Sensor/s (20) and ambient condition measuring sensors (21 to 25) with the Gateway (30).

Gateway (30) is the box that comprises:
the electronic module (40),
Switching Mode Power Supply (SMPS) (31),
adjustment component (32) and
warning component (33) and
panel mount connector/s (35)
power connection socket (AC) (34).

Gateway (30) enables the processed data to be transmitted to the cloud/server (70) to be accessible by the User interface (60). Gateway (30) must be designed in a way that is not affected by UV radiation and external influences. The power requirement is provided to gateway (30) by AC (Alternative Current) line connection or DC (Direct Current) sources or battery. If an AC line connection is present, AC line connection is established through a power connection socket (34). AC is converted to DC by a Switching Mode Power Supply (SMPS) (31).

Panel mount connector (35) is the connector that connects UV sensor/s (20) and ambient condition measuring sensor/s (if any) to the gateway (30). Panel mount connector (35) transmits data to electronic module (40) and also provides power from the gateway (30) to said sensors. Panel mount connector (35) allows connection of multiple UV sensor/s (20) and ambient condition measuring sensor/s.

The warning component (33) is the component that generates visible and/or audible warnings in case UV output values are below the permissible set level determined in the electronic module (40). And/or when any other parameter being monitored (e.g., temperature, air velocity, relative humidity, inner air quality, etc.,) is below or above the permissible set level determined in the electronic module (40).

Adjustment component (32) can be a button/switch or button/switch with LED and performs the actions indicated below:
selecting the type of transmission device (41) (i.e. Bluetooth, Wi-Fi, Ethernet, GSM, etc.),
selecting the mode of the transmission device (41) (i.e. set-up mode, operation mode),
showing the mode of the transmission device (41) (i.e. blinking LED indicator for set-up mode, steady lit LED indicator for operation mode) visually.

The electronic module (40) comprises a microprocessor and transmission device (41). The microprocessor provides processing of the data. The electronic module is the module that processes the data received from the sensors and transmits it to the cloud/server (70) via transmission device (41). The end user can access the transmitted data by the user interface (60). The electronic module (40) is microprocessor based. An algorithm/software is embedded in said microprocessor and provides processing of the data. Transmission device (41) can be wired (i.e. ethernet) or wireless (Wi-Fi, Bluetooth, GSM). In the electronic module, when the UV output value falls below the specified value, the necessary electronic outputs are created for the warning component of the system and for the user interface (60).

The electronic module (40) is an integrated structure of which, the UV sensor (20) and the ambient condition measuring sensor is a component of it, or as a separate module from the sensors, that processes the data received from the sensors and transmits it to the user interface (60) accessible for the end user.

The output of the UV sources (10) is directly related to the temperature of the environment in which they operate and the operating time of the UV source (10). The electronic module (40) enables automatic calibration by taking the measured value as the highest reference value or allows assignment of the measured value as the highest reference by an authorized user. The electronic module (40) not only allows the measured value to be assigned as the highest reference value (one hundred percent) but also provides the feature to assign it to any desired ratio (seventy percent, fifty percent, etc.).

Temperature, relative humidity, pressure, air velocity, air quality, and the particle count in the air can be monitored and displayed through different sensors (21, 22, 23, 24, 25) that can communicate with the same electronic module (40).

The user interface (60) is the interface/screen where the data, the values measured by the sensors, the graph demonstrating the change in the UV output over time, the calibration setting, the working hours of the UV sources (10), and the theoretical remaining life of the UV sources (10), and system generated alarms/warnings are displayed and visualized to the user.

Gateways (30) can be grouped according to their installation location using the user interface that comprises a multi-stage authorization system. Sensors within each group are automatically assigned and addressed through the embedded software ran in the microprocessor. In case of any problem or alerting condition (i.e., Output dropping below set limits) detected in a UV source (10), direct access to the problematic source is provided by using this address information. The information obtained from the sensors in real-time is displayed on the user interface (60) according to the specified refresh time. There is the possibility of accessing system information retrospectively by recording and filing this information. In case a problem is detected in any UV source (10) within an independent or grouped structure, a visual warning is created on the user interface (60), and the authorized user is informed via screen and/or communication channels such as email, SMS, etc. The hardware and software infrastructure that provides continuous online and offline access to the user interface (60) has been designed.

The user interface (60) displays the information that was transmitted to the cloud/server (70) and is the section where the interventions to be made to the system and the warnings to be sent to the user as a result of the processing of measurements from UV and other sensors in the created algorithm are located and displayed. The user interface (60) can provide necessary warnings to the user via screen, email, SMS, etc. The user interface (60) can be accessed by laptop, desktop computer, mobile application, etc.

Communication between sensors, electronic module (40), gateway (30), and user interface (60) can be carried out wirelessly or wired.

The process steps performed with the system, which is subject of the invention are as follows;
Continuously measuring the output of the UV source (10) via the UV sensor/s (20) and transferring output information to the electronic module (40),
processing the data received from the UV sensor/s (20) in the electronic module (40) and transferring the data to a cloud/server (70) or offline medium via transmission device (41),
displaying data, time-dependent graphs of the processed signal received via electronic module (40), calibration setting, theoretical remaining life of the UV Source, and other information which can be requested by the user by the user interface (60) of cloud/server (70) or offline medium, based on processed data and software in the electronic module (40).

In case the system comprises ambient condition measuring sensors (21 to 25): the method also comprises the following steps:
continuously measuring the ambient conditions (11) where the UV source (10) is located via the ambient condition measuring sensors and transferring it to the electronic module (40),
processing the data received from the ambient condition measuring sensor/s in the electronic module (40) and transferring the data to the cloud/server (70) or offline medium via transmission device (41).

Said other information can be the information that the user can request to be displayed.

In the step of measuring the ambient conditions (11) where the UV source (10) is located via the ambient condition measuring sensors and transferring it to the electronic module (40), the measurement is performed as indicated below:
when the temperature is to be monitored in the ambient conditions, the temperature of the environment is measured via temperature sensor (21)
when pressure is to be monitored in the ambient conditions, the pressure of the environment is measured via pressure sensor (22)
when relative humidity is to be monitored in the ambient conditions, relative humidity of the environment is measured via a relative humidity sensor (23)
when air velocity is to be monitored in the ambient conditions, air velocity is measured via air velocity sensor (24)
when indoor air quality is to be monitored in the ambient conditions, the indoor air quality of the environment is measured via indoor air quality sensors (25), particulate matter sensors, and toxic gas sensors (carbon dioxide-ethylene, etc.).
when more than one parameter or all parameters are to be monitored, then appropriate sensors for the measurement are used.

The method also comprises the step of generating alerts and warnings to the user via the user interface (60) and creating signals through the electronic module (40) that can intervene with other peripheral elements (i.e., fans, dampers, etc.,) of the system when needed/desired.

1. A system for wired/wireless-online/offline communication-based continuous, real-time proportional and radiometric measurement, processing, and monitoring of the output of UV sources that generate UV radiation that can be used in water disinfection, surface disinfection, air and room disinfection processes and for non-disinfection purposes, the system comprising:
a UV sensor or sensors which are positioned where a UV source or sources are located and continuously measures the output of the UV source or sources and transmits output information to an electronic module,
an electronic module which processes the data received from UV sensor or sensors,
a transmission device which transmits processed data to a cloud/server or an offline medium,
a user interface specific to the system installed on a cloud/server or offline environment, displaying data, time-dependent graphs of the processed signal received via the electronic module, calibration setting, the working hours of the UV sources, theoretical remaining life of the UV source or sources and other information which can be requested by the user.

2. The system according to claim 1, wherein the system comprises:
a gateway in which the electronic module is positioned; and
panel mount connector/s
which connects the UV sensor or sensors to the gateway in order to allow connection of multiple sensors; and
which transmits data received from sensor/s to the electronic module and also provides power from the gateway to said sensor or sensors.

3. The system according to claim 2, wherein the system comprises an AC line connection, DC sources, or a battery, in order to provide the power requirement of the gateway.

4. The system according to claim 3, wherein the system comprises a Switching Mode Power Supply (SMPS) which converts AC energy to DC energy, and a power connection socket.

5. The system according to claim 1, wherein the system comprises a warning component that generates an audible and/or visible warning in case UV output and/or any other monitored parameter is below or above a permissible set level determined in the electronic module.

6. The system according to claim 1, wherein the system comprises an adjustment component which performs:
selecting the type of transmission device; and/or
selecting the mode of the transmission device; and/or
showing the mode of the transmission device visually.

7. The system according to claim 1, wherein the transmission device is wired or wireless.

8. The system according to claim 1, wherein the system comprises a connection cable set which includes a connection cable and in-line cable connectors that provide the electrical and data connectivity between the UV sensor or sensors and the gateway.

9. The system according to claim 1, wherein said user interface allows the intervention to the system based on the data provided by embedded program running in electronic module that processes the information and measurements, as well as the warnings that will be transmitted to the user.

10. The system according to claim 1, comprising at least one ambient condition measuring sensor which is positioned in devices utilizing UV technology or in the environment where the UV source is located to measure the ambient conditions according to their characteristics.

11. The system according to claim 10, wherein the ambient condition measuring sensor is a temperature sensor measures the temperature of the environment, and/or a pressure sensor which measures the pressure of the environment and/or a relative humidity sensor which measures the relative humidity of the environment and/or an air velocity measuring sensor which measures the velocity of the air in the environment or the air passing through the UV source and/or an indoor air quality sensor that measures the indoor air quality of the environment through sensors such as particulate matter sensors, toxic gases sensors.

12. The system according to claim 1, wherein the user interface provides the necessary warnings to the user in the form of screen, e-mail, and SMS.

13. The system according to claim 1, wherein the electronic module assigns master/slave modules and transmits information received from a multi-module structure to the user interface as one single module.

14. A method for wired/wireless-online/offline communication-based continuous real-time proportional and radiometric measurement, processing, and monitoring of the output of UV sources which generates UV radiation that can be used in water disinfection, surface disinfection, air and room disinfection processes and for non-disinfection purposes, the method comprising the following process steps:
continuously measuring the output of a UV source or sources via a UV sensor or sensors and transferring output information to an electronic module;
processing data received from the UV sensor or sensors in the electronic module and transferring the data to a cloud/server or offline medium via a transmission device; and
displaying data, time-dependent graphs of the processed signal received via the electronic module, calibration setting, working hours of the UV source or sources, theoretical remaining life of the UV source or sources, and other information that can be requested by the user by a user interface of the cloud/server or offline medium, based on processed data and software in the electronic module.

15. The method according to claim 14, wherein the electronic module has audible/visual/electronic output/contact output that can activate warning components when the UV output value falls below the specified value.

16. The method according to claim 14, comprising continuously measuring ambient conditions where the UV source is located via an ambient condition measuring sensor/s and transferring it to the electronic module, processing the data received from the ambient condition measuring sensor/s in the electronic module and transferring the data to the cloud/server or offline medium via transmission device.

17. The method according to claim 16, comprising measuring the temperature of the environment via a temperature sensor in the step of measuring the ambient conditions and/or measuring pressure of the environment via a pressure sensor in the step of measuring the ambient conditions and/or measuring relative humidity of the environment via a relative humidity sensor in the step measuring the ambient conditions and/or measuring a velocity of the air in the environment where the UV source is located, or the velocity of air passing through the UV source via an air velocity sensor in the step measuring the ambient conditions and/or measuring indoor air quality of the environment via an indoor air quality sensor, particulate matter sensors, toxic gas sensors, in the step measuring the ambient conditions.

18. The method according to claim 14, comprising the step of generating alerts and warnings to the user via the user interface and creating signals that can intervene with other peripherical elements of the system, according to pre-set settings and algorithm running in the electronic module when needed/desired.
